(19) United States
(12) Patent Application Publication
(10) Pub. No.: US 2003/0001886 A1
(43) Pub. Date: Jan. 2, 2003

(54) Method for automatically guiding a user to link with a network

(76) Inventors: Kuang-Shin Lin, Taipei (TW); Sayling Wen, Taipei (TW); Xue-Wu Wang, Tianjin (CN)

Correspondence Address: BIRCH STEWART KOLASCH & BIRCH, PO BOX 747, FALLS CHURCH, VA, 22040-0747, US

(21) Appl. No.: 10/183,557

(22) Filed: Jun. 28, 2002

(30) Foreign Application Priority Data
Jun. 29, 2001 (TW) 90115899

(51) Int. Cl. G09G 5/00

(52) U.S. Cl. 345/738

(57) ABSTRACT

The specification discloses a method for automatically guiding a user to link with a network. It is a utility within an OS that can operate with different OS's. The user can perform a desired operation with a single action using the UOI provided by the invention. The disclosed method guides the user to automatically link with a network and to perform browsing. The disclosed method includes at least the steps of initiating the one-touch OS and producing a browser interface, presenting selection items on the browser interface, and providing selective input methods according to the browser interface to carry out processing and to complete browsing data.

### BACKGROUND OF THE INVENTION

1. Field of the Invention

The invention relates to an OS (Operating System), and more particularly to a method that can be used with different OS's to automatically guide a user to link with a network.

2. Related Art

With the increase in computer popularity and functionality, people often need to use computers to solve problems either at work or at home. In general, two major methods of obtaining information are (1) from books, newspapers, journals, or CD-ROM's, and (2) from the network. However, both of these methods have some drawbacks. First, the information obtained using the first method will become outdated as time progresses. The rapid exchange of information greatly shortens the life cycle of information. But such information as that recorded in media like books or journals cannot be easily updated. The information obtained using the second method, however, continuously changes along with the developing world around us, also resulting in some troubles for users. One can see the problems from the following points:

1. Existing personal computer OS's (Operating System), such as MS Windows or Linux, are complicated despite their powerful functions and designs. Moreover, user interface designs are not intuitive and simple enough. This situation scares people without any computer background because of the obstacles they meet while using these systems.

2. Users who search for data over a network may waste a lot of time waiting for data transmission due to the slow speed of their network system.

3. Some users may not know where to start their searches because they are not familiar with the network structure. Facing this situation, the user often chooses the OS that s/he is familiar with or installs different OS's on the computer and switches between them when necessary. Such a system with two co-existing OS's is called a dual-OS. Nevertheless, not all currently available browsers can help users to link with a network. The user has to enter website addresses by him or her self. The drawback is that when a user has never used a browser or does not know the website address, using browsers becomes a rather difficult task. It is thus highly desirable to provide a simple and convenient OS to solve this problem.

### SUMMARY OF THE INVENTION

In view of the foregoing, the invention provides a method for automatically guiding a user to link with a network. The method is based on a one-touch OS, whose main objective is to allow the use of a finite number of keys as hot keys to perform various functions. In this OS, each function is initiated by a single key, thus allowing for convenient and intuitive operation and increasing users' interest in using computers.

Furthermore, the invention provides an intuitive browser, with which the user does not need to learn how to use the browser. Simply following the hints provided by the system, the user can connect to the network and surf the web.

The one-touch OS is mainly designed for people without any computer background. It provides a simple and intuitive UOI (User Operating Interface) and an OS that can operate with the existing system. Therefore, two OS's are simultaneously present in the computer's hardware platform; this is called the dual-OS.

In accordance with the above advantages, any computer featuring the disclosed method for automatically guiding the user to connect to a network allows the user to conveniently and quickly obtain desired information. Such extra benefits can further facilitate computer sales and use.

### BRIEF DESCRIPTION OF THE DRAWINGS

The invention will become more fully understood from the detailed description given hereinbelow. However, this description is provided for purposes of illustration only, and thus is not limitative of the invention, wherein:

FIG. 1-a shows a flowchart of a first part of the disclosed method;

FIG. 1-b shows a flowchart of a second part of the disclosed method; and

FIG. 1-c shows a flowchart of a third part of the disclosed method.

### DETAILED DESCRIPTION OF THE INVENTION

The invention proposes a method for automatically guiding a user to link with a network. In particular, in contrast to currently available complicated OS's, a convenient and intuitive UOI (User Operating Interface) is provided herein so that the user can complete a desired effect with a single hot key on a keyboard. Through a network connection, the user can achieve the goal of real-time data browsing, transmission and updating through the one-touch OS.

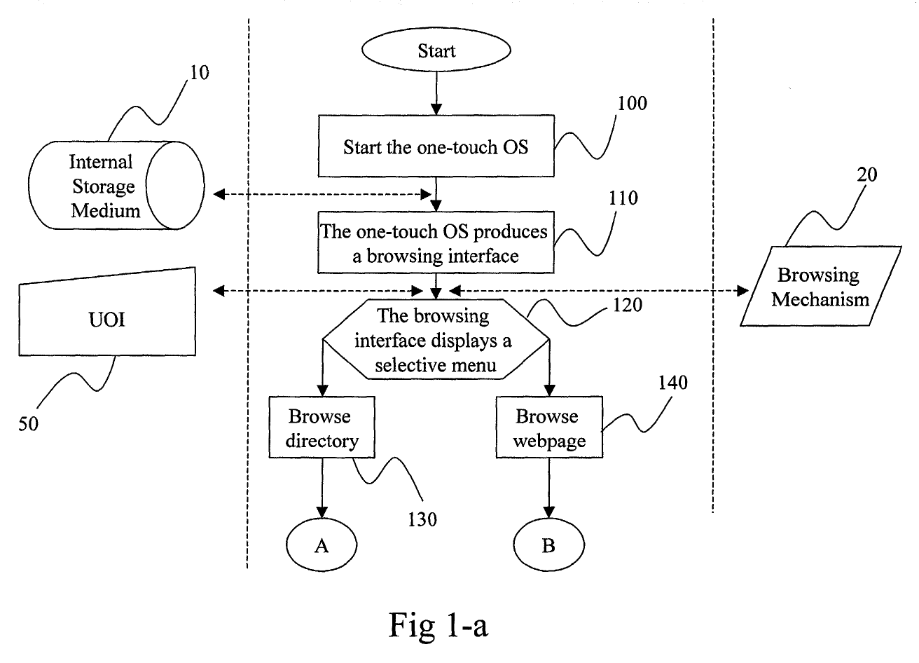

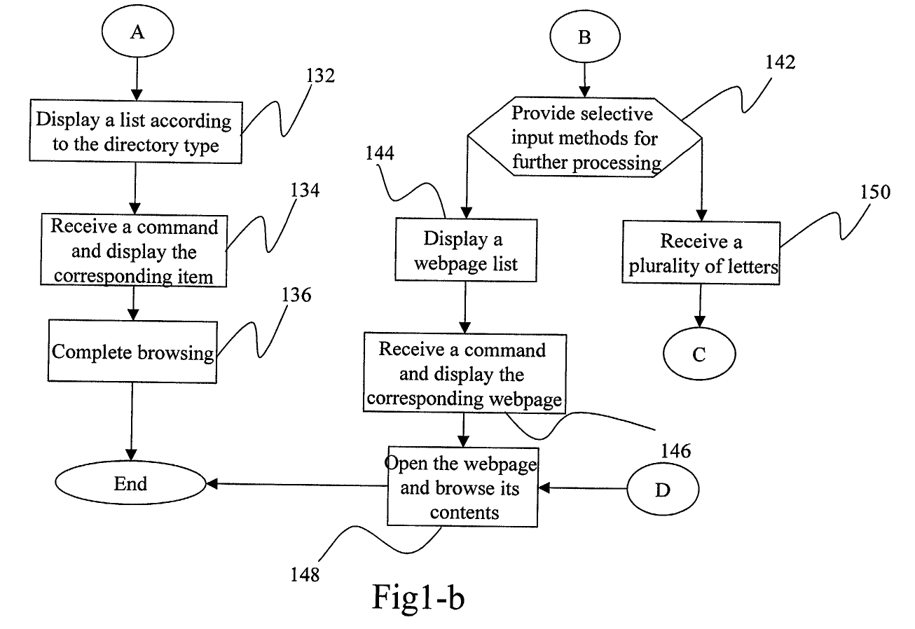

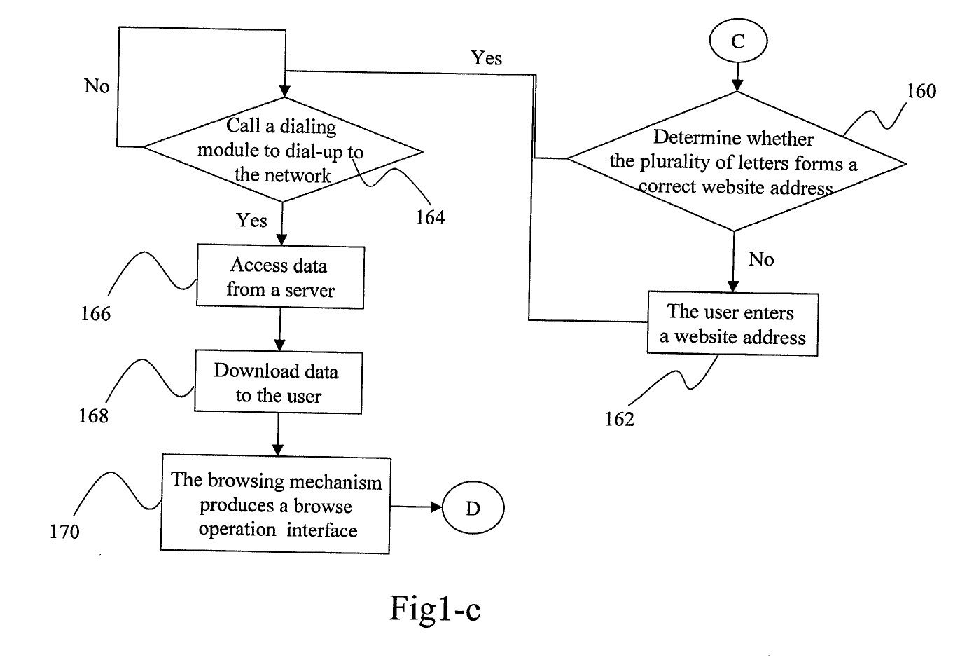

A preferred embodiment is given below to demonstrate the feasibility of the disclosed method. As shown in FIG. 1, the user starts the one-touch OS (step 100). The one-touch OS is stored in an internal storage medium 10 of a computer controlled hardware platform. The one-touch OS then produces a browsing interface (step 110), where the browsing interface is provided by a browsing mechanism 20 in the one-touch OS. Therefore, the user can perform actions in a browsing interface work menu through the UOI. The browsing interface then displays a selective menu (step 120). The selection item is further divided into the browse directory method (step 130) and the browse webpage method (step 140). If step 130 is selected, then step A follows; if step 140 is selected, step B follows.

The one-touch OS 100 refers to an OS that enables a user to complete a function provided in the work group displayed in a UOI 50 in one action. The work group is comprised of at least one function item. The one-touch OS 100 can operate with different OS's or alone. The user can choose to switch between the different OS's.

With reference to FIG. 1-b, after entering step A, a list is presented according to the directory type (step 132). This list shows all file directories in the system. The browsing mechanism 20 then receives a command and displays the corresponding item (step 134). The command given by the user is to select an item from the list. Finally, the browsing procedure is completed (step 136). If the procedure enters step B, the browsing mechanism 20 provides selective input methods for further processing (step 142). The input methods include an auto input and a manual input. When auto input is selected, the browsing mechanism 20 displays a webpage list (step 144). A command is received and the corresponding webpage is displayed (step 146). The command is given by the user by clicking a default website address in the one-touch OS. The user can thus open the webpage and browse its contents (step 148). If manual input is selected, the browsing mechanism 20 receives a plurality of letters (step 150) and step C follows.

With reference to FIG. 1-c, after entering step C, the browsing mechanism 20 determines whether the plurality of letters forms a correct website address (step 160). If it is not a correct website address, the user is asked to enter a new website address (step 162). If the website address is correct, the browsing mechanism 20 calls a dialing module to dial up to the network (step 164) and automatically establish a connection with the network. Data from a server are accessed (step 166) and downloaded to the user (step 168). The browsing mechanism 20 then produces a browse operating interface (step 170) and returns to step D. Returning to FIG. 1-b, the user can open the webpage and browse its contents (step 148).

The one-touch OS 100 can run on any computer controlled hardware platform, such as a PC (Personal Computer), an NB (Notebook), or a PDA (Personal Digital Assistant). Any person skilled in the art can make various modifications in order to implement the disclosed method of automatically guiding a user to link with a network in any electronic device that can establish communications with a network.

As described above, a user can complete a desired task by performing only a single action. The UOI provides at least one hint menu so that the user can follow the menu to input and execute the task in a single action. In the current embodiment, the single action function offered by the one-touch OS 100 allows the user to press one key on the keyboard according to a selection menu to enter his request. Any key on the keyboard can be set to complete this kind of action. The keys include the number keys 0˜9, the letter keys A˜Z, the function keys F1˜F12 and special keys ESC, TAB, PgUp, END, etc. Aside from the keyboard, single action request input can be accomplished using a mouse or other controllers, such as a digital touch-control panel or a voice recognition system. That is, any basic computer input device can be used to provide one-touch control.

When the user wants to browse a particular webpage, the disclosed method can establish a connection with a network according to the data recorded in a database. When the user wants to leave the network service program, the disclosed method can automatically disconnect from the network as well. In other words, the user does not need to perform extra network setting and connection actions. Therefore, the user can use the network services provided by the computer in a more intuitive way. Users who are not familiar with computers will also become more interested in web browsing using computers.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for automatically guiding a user to link with a network used in a one-touch OS (Operating System) running on a computer controlled hardware platform, where a browsing mechanism is used to browse data and a user connects to the network through a UOI (User Operating Interface), the method comprising the steps of:
starting the one-touch OS and producing a browsing interface;
displaying a selective menu on the browsing interface;
providing selective input methods for further processing by the browsing mechanism; and
complete the data browsing.

2. The method of claim 1, wherein the one-touch OS is an OS that enables a user to complete a function provided in the work group displayed in an interface generating module 150 in one action.

3. The method of claim 2, wherein the work group is comprised of at least one function item.

4. The method of claim 2, wherein the single action refers to the action that the user follows a selection menu generated by the UOI to perform controls using a basic I/O (Input/Output) device provided by the computer controlled hardware platform.

5. The method of claim 4, wherein the basic I/O device is selected from the group comprising a keyboard, a mouse, a digital touch-control panel and a voice recognition system.

6. The method of claim 2, wherein the UOI generates at least one set of the work group.

7. The method of claim 1, wherein the one-touch OS is able to operate with other different OS's and the user determines to switch among the different OS's.

8. The method of claim 1, wherein the one-touch OS operates alone.

9. The method of claim 1, wherein the computer controlled hardware platform is selected from the group comprising a PC (Personal Computer), an NB (Notebook), and a PDA (Personal Digital Assistant).

10. The method of claim 1, wherein the one-touch OS is stored in an internal storage medium of the computer controlled hardware platform.

11. The method of claim 1, wherein the browsing interface displays a selection menu including a browse directory and a browse webpage.

12. The method of claim 11, wherein the brows directory further comprises the steps of:
displaying a list according to a directory type; and
receiving a command and displaying the corresponding item.

13. The method of claim 12, wherein the command is an item selected from the list.

14. The method of claim 11, wherein the step of browse webpage further provides selective input methods, including an auto input and a manual input.

15. The method of claim 14, wherein the auto input method further comprises the steps of:
displaying a webpage list;
receiving a command and displaying the corresponding webpage; and
opening the webpage and browsing its contents.

16. The method of claim 15, wherein the command is given by the user by clicking a default website address in the one-touch OS.

17. The method of claim 14, wherein the manual input method further comprises the steps of:
receiving a plurality of letters;
determines whether the plurality of letters forms a correct website address;
displaying a webpage corresponding to the website address by the browsing mechanism; and
producing a browse operating interface by the browsing mechanism.

18. The method of claim 17, wherein the step of displaying a webpage corresponding to the website address further comprises the step of:
calling a dialing module to dial up to the network;
accessing data from a server; and
downloading the data to the user.
